(19) United States
(12) Patent Application Publication
(10) Pub. No.: US 2012/0287634 A1
(43) Pub. Date: Nov. 15, 2012

(54) WEATHER PROOF HIGH EFFICIENT LED LIGHT ENGINE

(75) Inventor: Alex Kochetkov, Schaumburg, IL (US)

(73) Assignee: Schneider Electric USA, Inc., Palatine, IL (US)

(21) Appl. No.: 13/465,199

(22) Filed: May 7, 2012

Related U.S. Application Data
(60) Provisional application No. 61/485,894, filed on May 13, 2011.

(51) Int. Cl. F21V 5/04; F21V 29/00

(52) U.S. Cl. 362/244

(57) ABSTRACT

A printed circuit board assembly (PCBA) having a printed circuit board (PCB) with an array of light emitting diodes, multiple optic devices, and an overmold covering parts of the optic devices and the PCB. The optic devices have a stepped flange such that the lowermost step is covered completely by the overmold, thereby mechanically anchoring the optic device to the PCB. The overmold edges include wire covers with corresponding wire channels to retain wires within the channels. When multiple PCBAs are arranged together to form a light fixture, wires can be tucked under the wire covers so that they are protected and concealed. The overmold completely covers the PCB and includes a sealing edge that compresses or deforms when the back of the PCB is secured to a heat sink, creating a watertight and weatherproof seal around the PCB, preventing debris and water ingress into the PCB and optic devices.

### CROSS-REFERENCE TO RELATED APPLICATION

This application claims the benefit of U.S. Provisional Patent Application Ser. No. 61/485,894, filed May 13, 2011, entitled “Weather Proof High Efficient Led Light Engine” which is hereby incorporated by reference herein in its entirety.

### FIELD OF THE INVENTION

The present disclosure relates generally to lighting assemblies, and more particularly, to a lighting assembly having a weatherproof overmold.

### BACKGROUND OF THE INVENTION

Lights such as area lights, particularly those used in outdoor applications, are exposed to harsh environmental conditions, including rain, dust, pollen, and the like. In dirty indoor environments, the area lights can be exposed to dust and water. Traditionally, to protect the light elements, such as light emitting diodes (LEDs) from the elements, a glass lens is added to the fixtures to keep harmful substances from entering the interior of the fixture, which can degrade the LEDs and reduce the efficacy and light output of the area light over time. The glass diminishes the light output of the LEDs and even more so as it becomes scratched and/or discolored over time.

In addition, LEDs are typically mounted to a printed circuit board (PCB), with exposed electrical components that can be damaged or short-circuited by external elements, like mechanical objects or water. Moreover, wires are needed to supply power to the PCBs, and exposed wires are further susceptible to wear and tear over time. Wires also look unsightly, and the exposed surfaces of PCBs can be undesirable.

The present disclosure overcomes these and other problems and shortcomings.

### SUMMARY OF THE INVENTION

According to an implementation of the present disclosure, an assembly is provided, which includes a printed circuit board (PCB) having arranged on a front surface thereof a plurality of light elements; a plurality of optic devices each having a lens arranged over respective ones of the light elements to allow light emitted by each of the light elements to pass through the lens; and an overmold composed of an electrically insulating material and formed over the front surface of the PCB such that portions of the overmold extend over the corresponding stepped flange of each of the optic devices to mechanically retain the optic devices relative to the PCB. Each of the optic devices includes at a base thereof a stepped flange opposing the front surface of the PCB.

The overmold can further include a sealing edge extending around at least a periphery of the overmold and extending beyond a back surface opposite the front surface of the PCB. The assembly can further include a heat sink secured to the back surface of the PCB. The sealing edge can be deformably compressed against the heat sink to form a seal between the front surface of the PCB and a back surface of the overmold.

The overmold can further include a wire cover protruding away from an edge of the overmold. The wire cover can include a wire channel dimensioned to receive therein a wire. The overmold can further include a second wire cover protruding away from a second edge of the overmold. The second wire cover can include a second wire channel dimensioned to receive therein a second wire.

The stepped flange can include at least two steps at the base such that the first step is surrounded by the overmold and a major exposed surface of the overmold extends at least to a top of the second step. The top of the second step of each of the optic devices can be flush with the exposed surface of the overmold.

Each of the light elements can be a light emitting diode (LED). The electrically insulating material can include a thermoplastic or thermosetting plastic material. The overmold can be injection-molded over the front surface of the PCB and over at least a portion of the base of the optic devices.

The base of each of the optic devices can include a channel formed on a bottom surface of the base opposing the front surface of the PCB. The channel can be dimensioned to receive therein an adhesive for maintaining the optic device on the PCB as the overmold is formed thereover.

Each of the optic devices can include a recessed pocket forming an opening in a bottom surface of the base opposing the front surface of the PCB. The recessed pocket can be dimensioned to cover one of the light elements.

According to another implementation of the present disclosure an apparatus includes a plurality of assemblies. Each of the assemblies include a printed circuit board (PCB) having arranged on a front surface thereof a plurality of light elements. The PCB includes at least one wire lead connected to a wire. Each assembly further includes a plurality of optic devices each having a lens arranged over respective ones of the light elements to allow light emitted by each of the light elements to pass through the lens. Each of the optic devices includes at a base thereof a stepped flange opposing the front surface of the PCB. Each assembly also includes an overmold composed of an electrically insulating material and formed over the front surface of the PCB such that the overmold extends over the corresponding stepped flange of each of the optic devices to mechanically anchor the optic devices relative to the PCB. The overmold includes a wire cover protruding away from an edge of the overmold. The wire cover includes a wire channel dimensioned to receive therein the wire or a wire associated with another one of the assemblies. The wire associated with a first of the assemblies is received in the wire channel of a second of the assemblies.

The apparatus can further include a heat sink. The back surface of each of the PCBs (of each assembly) can be secured to the heat sink.

Each of the overmolds can include a sealing edge extending around at least a periphery of the overmold and extending beyond a back surface opposite the front surface of the PCB. The sealing edge can be deformably compressed against the heat sink to form a seal between the front surface of the PCB and a back surface of the overmold.

Each of the assemblies can have four sides. The wire cover can be four wire covers. Each of the wire covers can protrude away from corresponding ones of the four sides and each of the wire covers can include a corresponding wire channel for receiving therein a wire.

The stepped flange can include a first step and a second step such that the first step is covered by the overmold and a major exposed surface of the overmold is flush with a top of the second step.

The electrically insulating material can include a thermoplastic or thermosetting plastic material. The overmold can be injection-molded over the front surface of the PCB and over the first step of each of the optic devices such that the overmold completely covers the front surface of the PCB.

Each of the light elements can include a light emitting diode (LED).

The base of each of the optic devices can include a channel formed on a bottom surface of the base opposing the front surface of the PCB. The channel can be dimensioned to receive therein an adhesive for temporarily securing the optic device to the PCB as the overmold is formed thereover.

Each of the optic devices can include a recessed pocket forming an opening in a bottom surface of the base opposing the front surface of the PCB. The recessed pocket can be dimensioned to cover one of the light elements.

The foregoing and additional aspects and implementations of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

FIG. 1A an exploded top perspective view of an assembly according to an implementation of the present disclosure;

FIG. 1B is an exploded bottom perspective view of the assembly shown in FIG. 1A;

FIG. 2 is a top plan view of the assembly shown in FIG. 1A without the heat sink;

FIG. 3 is a cross-sectional view of the assembly shown in FIG. 2 taken along the lines 3-3 shown in FIG. 2;

FIG. 4 is a cross-sectional view of the assembly shown in FIG. 2 taken along the lines 4-4 shown in FIG. 2;

FIG. 5 is a perspective view of an optic device used in the assembly shown in FIG. 1A;

FIG. 6 is a bottom perspective view of the optic device shown in FIG. 5;

FIG. 7 is a top plan view of the optic device shown in FIG. 5;

FIG. 8 is an exploded view of a cross-section of the optic device taken along lines 8-8 shown in FIG. 7 before it is temporarily secured to a PCB over a light element;

FIG. 9 is a cross-sectional view of the optic device shown in FIG. 7 taken along lines 9-9;

FIG. 10A is a cross-sectional view of an edge of the assembly just before it is secured to a heat sink with a downwardly protruding sealing edge;

FIG. 10B is a cross-sectional view of the edge shown in FIG. 10A after the overmold has been secured to the heat sink and showing the compression of the sealing edge shown in FIG. 10A; and

FIG. 11 is a top view of an exemplary configuration of multiple assemblies like the one shown in FIG. 2 showing the wire management aspects of the overmold according to an implementation of the present disclosure.

### DETAILED DESCRIPTION

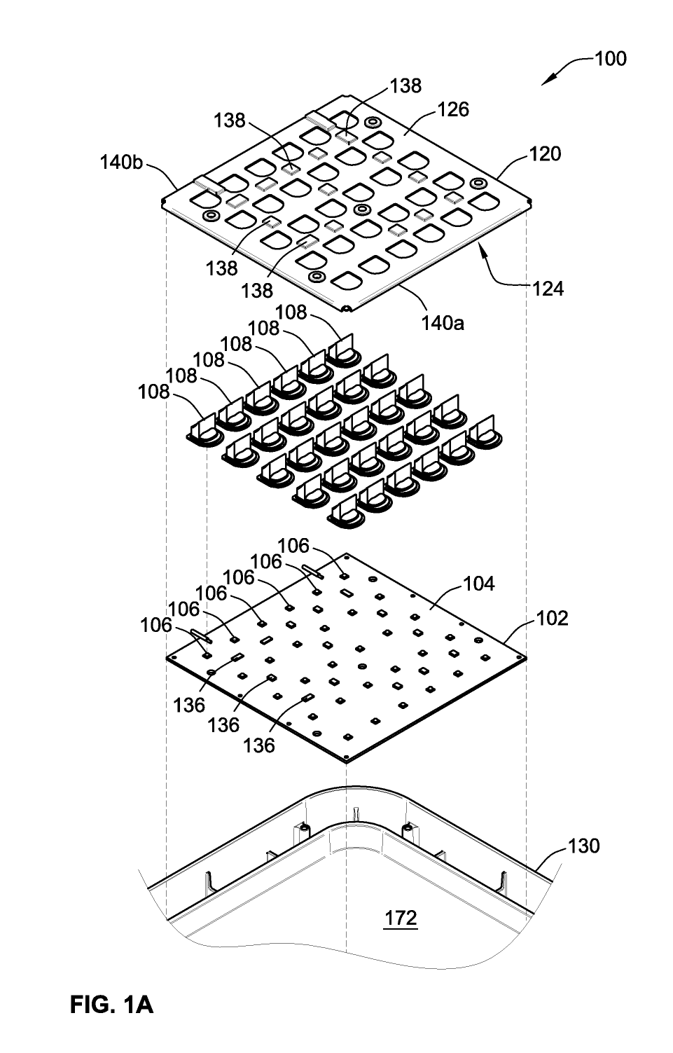

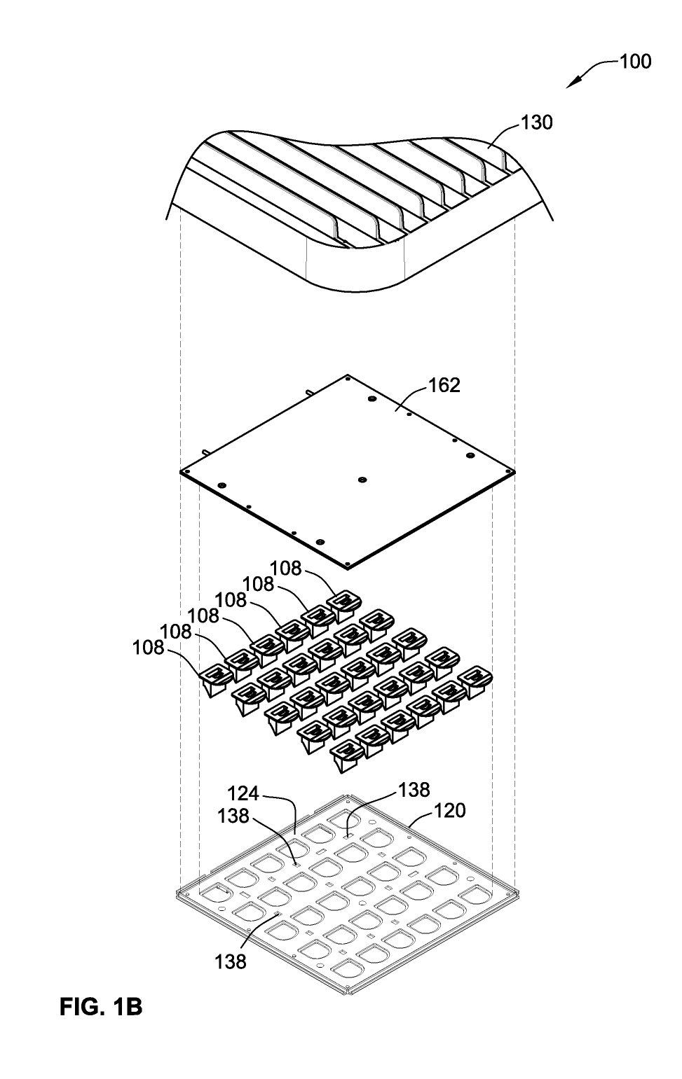

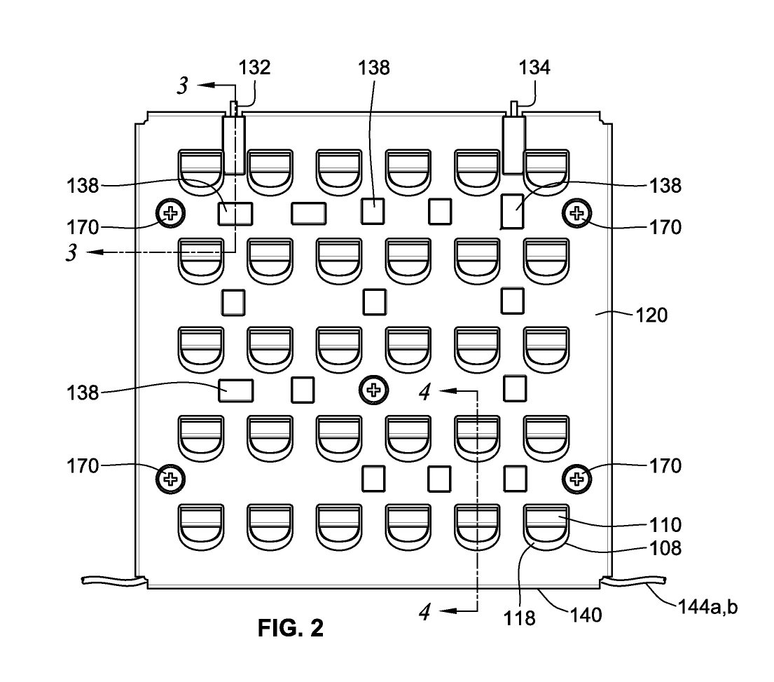

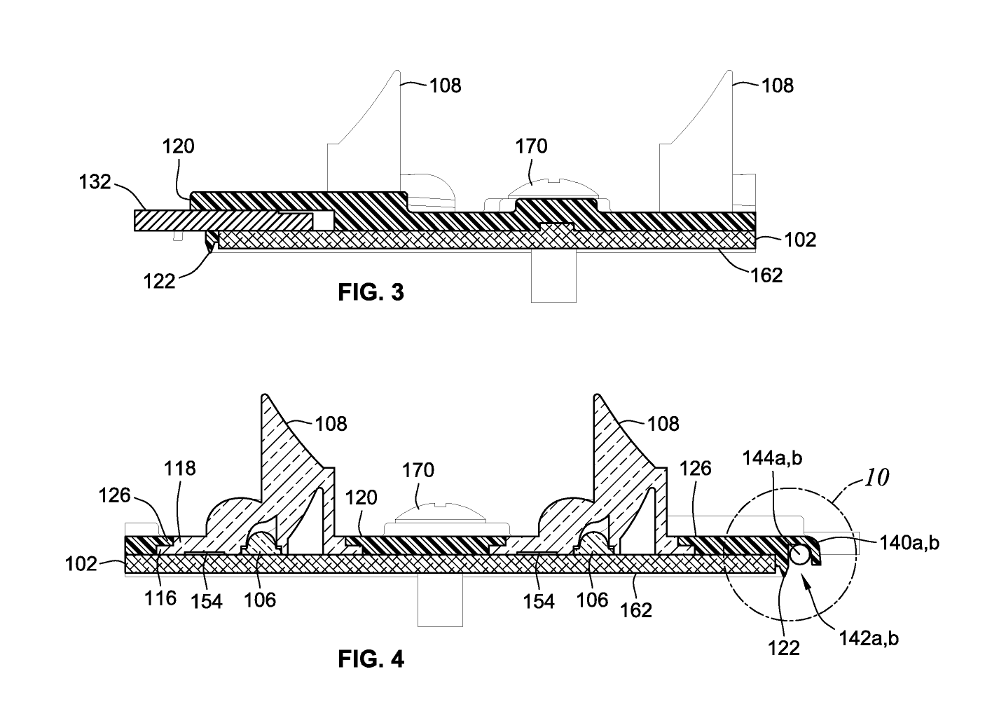

FIG. 1 illustrates an exploded top perspective view of an assembly 100 according to an implementation of the present disclosure, and FIG. 2 is an exploded perspective view taken from a bottom of the assembly shown in FIG. 1. The assembly 100 includes a printed circuit board 102 (PCB) having arranged on a front surface 104 thereof an array or arrangement of light engines or light elements 106 (in the illustrated example, there are 36 light elements arranged as an array of 6×6 elements). By way of example, the light elements 106 can be light emitting diodes (LEDs). The assembly further includes multiple optic devices 108 each having a lens 110 arranged over each of the light elements 106 (see FIG. 4) to permit light emitted by each of the light elements 106 to pass through the lens 110. Each of the optic devices 108 has a base 112, which includes a stepped flange 114 opposing the front surface 104 of the PCB 102. The present disclosure is not limited to any particular number or arrangement of light elements 106. In this example, the assembly 100 has a generally square shape with four sides, but the present disclosure is not intended to limit the assembly to any particular geometric form or shape.

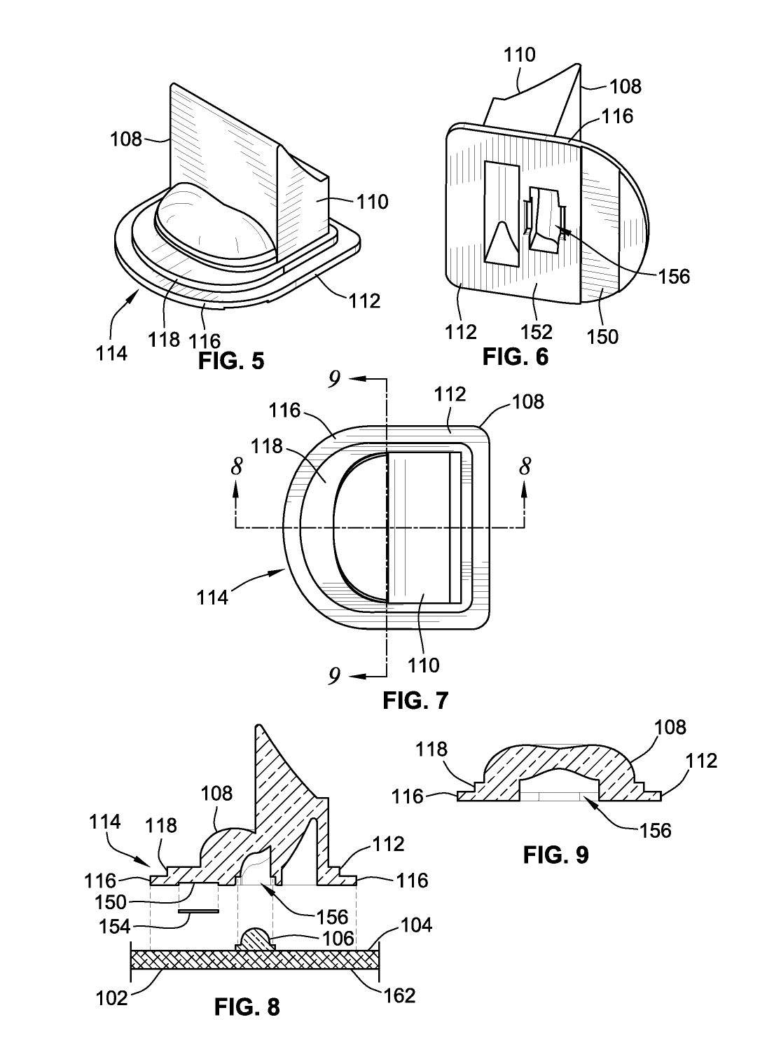

The assembly 100 further includes an overmold 120 composed of an electrically insulating material (such as a thermoplastic or thermosetting plastic material as required by UL1598 and UL8750). As used herein, the term “overmold” has the meaning as understood by those of ordinary skill in the art familiar with manufacturing processes, such as injection molding processes. The overmold 120 is formed over the front surface 104 of the PCB 102 such that portions of the overmold 120 extend over the corresponding stepped flange 114 of each of the optic devices 108 to mechanically retain the optic devices 108 relative to the PCB 102. The stepped flange 114 includes a first step 116 and a second step 118 at the base 112 (see FIG. 5) such that the first step 116 is completely submersed or surrounded or covered by the overmold 120 (see FIG. 4) and such that a major exposed surface 126 of the overmold 120 extends at least to a top of the second step 118 (FIG. 4). In other words, the top of the second step 118 is flush with the major exposed surface 126 of the overmold 120. This arrangement has the effect of sealing and anchoring the optic device 108 onto the PCB 102 (FIG. 4). Preferably, the overmold 120 completely covers or encapsulates the front surface 104 of the PCB 102, leaving only the back surface 162 of the PCB 102 exposed (even the edges of the PCB 102 are encapsulated by the sealing edge 122 as explained in more detail below). Gaskets on the mold tool used to form the overmold 120 prevent the overmold compound material from exceeding the level of the second step 118 during the mold injection process, thereby remaining flush with the top of the second step 118. The second step 118 and the tool opening are wider than the actual cavity of the optic device 108 (see FIG. 7), allowing some clearance for compensating for optic device placement tolerances (as explained below, the optic devices 108 can be temporarily secured to the PCB 102 by double-sided tape, which can lead to slight placement irregularities on the PCB 102). Together, the overmold 120, the PCB assembly 102, and the optic devices 108 form a PCB assembly or PCBA. The assembly 100 can further include a heat sink 130 secured (such as by mounting screws 170 shown in FIG. 2) to the back surface 162 of the PCB 102. The back surface 162 of the PCB 102 can be seen in FIG. 1B, which is secured into the heat sink 130 by the mounting screws 170.

The PCB 102 can include a metal (e.g., aluminum) core on a rear surface 162 of the PCB 102 and receives power from wire leads 132, 134 from a driver circuit (not shown) that conventionally drives the light elements 106 to selectively illuminate the light elements 106. In light fixtures, all of the light elements 106 are typically activated and deactivated simultaneously, but in other implementations, the light elements 106 can be selectively turned on and off, in which case the wire leads 132, 134 include one or more control signals. In addition to acting as a ground (earth) plane, for example, the metal core on the back 162 of the PCB 102 can also serve to conduct heat generated by the light elements 106 to the heat sink 130.

The overmold 120 includes a sealing edge 122 extending around at least a periphery of the overmold 120 and extending beyond or below a back surface 124 of the overmold 120 opposite the front surface 104 of the PCB 102. The sealing edge 122 is deformably compressed against the heat sink 130 to form a weatherproof seal against water and debris ingress between the front surface 104 of the PCB 102 and a back surface 124 of the overmold 120. The overmold 120 also offers mechanical protection of the electronic components on the PCB 102 including the light elements 106.

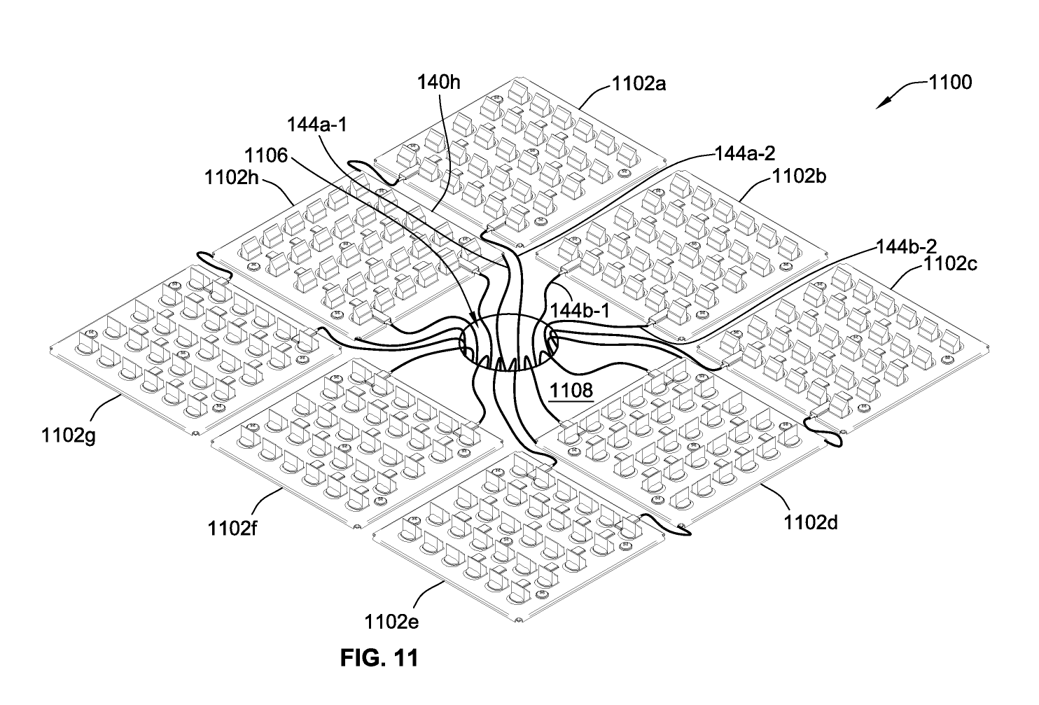

The overmold 120 includes a wire cover 140a protruding away from an edge of the overmold 120. The wire cover 140a includes a wire channel 142a dimensioned to receive therein a wire 144a. The overmold 120 includes a second wire cover 140b protruding away from a second edge of the overmold 120. The second wire cover 140b includes a second wire channel 142b dimensioned to receive therein a second wire 144b. The overmold 120 in the illustrated examples includes four sides, and at one, two, three, or all of the sides, a wire cover, such as the wire cover 140a,b, can be formed to receive within a corresponding wire channel a wire carrying power to the PCB 102 or to another PCB. The wire covers 140a,b are used for wire management, allowing the concealment and protection of the wires 144a,b inside the assembly 100, relieving wire strain, protecting them, and securely directing them along the edge to any side of the assembly 100. The wire covers 140a,b have a curved shape, resembling downwardly protruding fingers, and are slightly flexible and can adjust to a different number of wires (e.g., one or two) or to a different mounting spacing between adjacent PCBs 102 (described in more detail in connection with FIG. 11 below). For example, the wire cover 140 can be bent slightly upwards to allow a wire 144 to be fed underneath the wire channel 142, and then the wire cover 140 can be released so that it returns to its normal position.

Besides the light elements 106, the PCB 102 conventionally includes additional electronic components 136, such as resistors, capacitors, integrated circuits, and the like, which are not germane to the present disclosure. The overmold 120 can include corresponding cavities 138 to cover the protruding electronic components 136 as can be seen from FIG. 1A. When formed using an injection molding process, the overmold 120 can be made to completely conform to the front surface contour of the PCB 102.

The base 112 of each of the optic devices 108 includes a channel 150 formed on a bottom surface 152 of the base 112 opposing the front surface 104 of the PCB 102. The channel 150 is dimensioned to receive therein an adhesive 154 (such as double-sided tape or an epoxy, for example) for maintaining or temporarily securing the optic device 108 on the PCB 102 as the overmold 120 is formed thereover. Each of the optic devices 108 includes a recessed pocket 156 (shown in FIGS. 6, 8, and 9) defining an opening in the bottom surface 152 of the base 112 opposing the front surface 104 of the PCB 102. The recessed pocket 156 is dimensioned to cover one of the light elements 106. The base 112 is shaped so that the optic device 108 can be oriented onto the PCB 102 in only one direction, to ensure that all of the optic devices 108 are oriented in a common direction on the PCB 102, if desired.

To assemble the assembly 100, the optic devices 108 are positioned over the corresponding light elements 106 on the PCB 102, such as shown in FIG. 1A. Each of the optic devices 108 includes an adhesive 154, such as double-sided tape, on the bottom surface 152 of the base 112 of the optic device 108 to temporarily secure the optic device 108 to the PCB 102 (see FIGS. 4 and 8). The PCB assembly, which includes the optic devices 108 and the PCB 102, is placed into a molding machine having a custom matrix tool. A molding material compound (e.g., plastic) is injected into the cavity of the tool to create an even, precisely calculated layer of insulation, which follows the profile or contour of the PCB 102 and its components, leaving the lenses 110 and a rear surface 162 of the PCB 102 exposed. The metal core backing on the rear surface 162 is directly mounted to the heat sink 130 for effective heat management. Heat generated by the light elements 106, which is conducted toward the heat sink 130, is conducted through the metal core backing of the PCB 102 directly to the heat sink 130 for radiating the heat energy away from the assembly 100. The plastic molding material creates a solid bond with the PCB 102 and the optic devices 108, creating a watertight and weatherproof encapsulation.

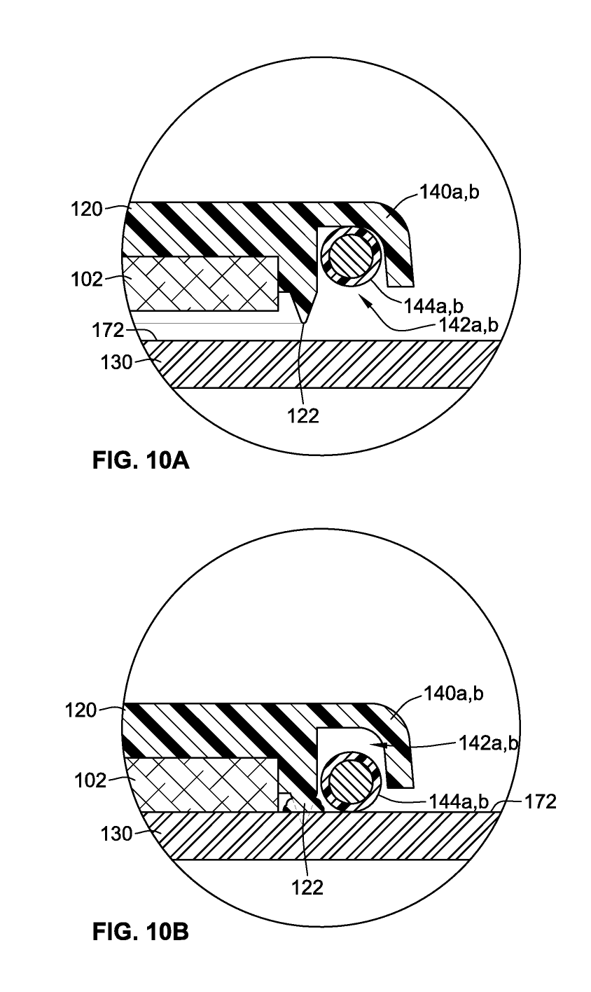

The overmold 120 when formed in accordance with the present disclosure satisfies or exceeds the IP65 rating (International Protection rating) as rated by the National Electrical Manufacturers Association as of the filing date of the present disclosure. The level 6 in the first number of the rating means that there is no ingress of dust into the PCB 102 (and correspondingly the light elements 106) and complete protection for the PCB 102 against contact. The level 5 in the second number of the rating means that the PCB 102 is protected from any harmful effects caused by jets of water projected by a nozzle (6.3 mm) against the overmold 120 from any direction. The stepped configuration of the base 112 of the optic devices 108 allows the molding material to create a tight seal around each of the optic devices 108, thereby protecting the PCB 102 and correspondingly the light elements 106 from debris and water. In addition, the conformal or deformable sealing edge 122 shown in FIGS. 10A and 10B further protect the assembly 100 against debris and water.

As can be seen from FIGS. 10A and 10B, when the mounting screws 170 (shown in FIG. 2) are tightened, the overmold 120 is pressed against an inner surface 172 of the heat sink 130. As mentioned above, the sealing edge 122 protrudes beyond or below the bottom of the PCB 102 as shown in FIG. 10A such that when the overmold 120 is pressed against the inner surface 172 of the heat sink 130, the sealing edge 122 compresses or deforms slightly as shown in FIG. 10B to provide a seal against debris and water ingress beneath the assembly 100 and from the side edge where the wire cover 140a,b is located. This sealing edge 122 can be located around the entire perimeter of the overmold 120. The sealing edge 122 has a triangular shape and terminates at a point, which gets compressed when the heat sink 130 is pressed against the back surface 162 of the PCB 102.

The overmold 120 allows for accelerated fabrication time with tighter controls for tolerances and optic device placement, resulting in a durable and cost-effective assembly. It provides corrosion protection for outdoor or dirty environments equal to a conformal coating process but at a substantially reduced cost. The entire assembly 100 is installed into a fixture, and no glass lens in the fixture is needed because the light elements 106 are hermetically protected by the overmold 120 and the optic devices 108 against water and debris. The absence of a glass lens in the fixture minimizes losses or attenuation from the light emitted by the light elements 106. The overall assembly 100 possesses stronger mechanical properties with enhanced isolation and rigidity compared to prior-art assemblies.

FIG. 11 illustrates an apparatus 1100 showing eight PCB assemblies 1100a-h, each like the PCBA described and shown above, arranged in an array to form the lighting element of a light fixture. Each PCBA 1100a,b,c,d,e,f,g,h is shown slightly spaced apart from one another for ease of illustration, but in an exemplary configuration, the PCBAs 1100a-h are closer together, nearly touching or touching one another. FIG. 11 shows how the overmold 120 facilitates effective wire management when using multiple assemblies. The corresponding wire covers 140 of the overmolds of each of the assemblies 1100 retain wire(s) from the PCB of the PCBA to which the wire is connected or wire(s) connected to another PCB of another PCBA. For example, the wire 144a-1 for the PCBA 1102a is captured under the wire cover 140h of the PCBA 1102h. Where the wire leads of the PCBs are oriented toward the opening 1106, the corresponding wires can be routed directly into the opening 1106, like the wires 144a-2 of the PCBA 1102a and 144b-1, b-2 of the PCBA 1102b. All of the wires from all of the PCBAs 1100a-h can be fed through a central opening 1106 where they are connected to a driver (not shown) for driving the light elements on the PCBs 102. The wire covers 140 flexibly allow the PCBAs to be arranged in any configuration with the flexibility to route the wires irrespective of how the PCBAs are oriented and along any edge thereof. All eight PCBAs 1102a-h are fastened to the heat sink 130 (not shown in FIG. 11) by mounting screws 170. A cover (not shown) can be placed over the wires 144 in the area 1108 surrounded by the PCBAs 1100a-h to protect and conceal them. The overall visual impression of the apparatus 1100 is clean and uncluttered, with the overmold 120 providing a pleasing visual appearance.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of the invention as defined in the appended claims.

What is claimed is:

1. An assembly, comprising:
a printed circuit board (PCB) having arranged on a front surface thereof a plurality of light elements;
a plurality of optic devices each having a lens arranged over respective ones of the light elements to allow light emitted by each of the light elements to pass through the lens, each of the optic devices including at a base thereof a stepped flange opposing the front surface of the PCB; and
an overmold composed of an electrically insulating material and formed over the front surface of the PCB such that portions of the overmold extend over the corresponding stepped flange of each of the optic devices to mechanically retain the optic devices relative to the PCB.

2. The assembly of claim 1, the overmold further including a sealing edge extending around at least a periphery of the overmold and extending beyond a back surface opposite the front surface of the PCB, the assembly further comprising:
a heat sink secured to the back surface of the PCB,
wherein the sealing edge is deformably compressed against the heat sink to form a seal between the front surface of the PCB and a back surface of the overmold.

3. The assembly of claim 1, wherein the overmold further comprises a wire cover protruding away from an edge of the overmold, the wire cover including a wire channel dimensioned to receive therein a wire.

4. The assembly of claim 3, wherein the overmold further comprises a second wire cover protruding away from a second edge of the overmold, the second wire cover including a second wire channel dimensioned to receive therein a second wire.

5. The assembly of claim 1, wherein the stepped flange includes at least two steps at the base such that the first step is surrounded by the overmold and a major exposed surface of the overmold extends at least to a top of the second step.

6. The assembly of claim 5, wherein the top of the second step of each of the optic devices is flush with the exposed surface of the overmold.

7. The assembly of claim 1, wherein each of the light elements is a light emitting diode (LED), and the electrically insulating material includes a thermoplastic or thermosetting plastic material, and the overmold is injection molded over the front surface of the PCB and over at least a portion of the base of the optic devices.

8. The assembly of claim 1, wherein the base of each of the optic devices includes a channel formed on a bottom surface of the base opposing the front surface of the PCB, the channel being dimensioned to receive therein an adhesive for maintaining the optic device on the PCB as the overmold is formed thereover.

9. The assembly of claim 1, wherein each of the optic devices includes a recessed pocket forming an opening in a bottom surface of the base opposing the front surface of the PCB, the recessed pocket being dimensioned to cover one of the light elements.

10. An apparatus, comprising:
a plurality of assemblies, each of the assemblies including:
a printed circuit board (PCB) having arranged on a front surface thereof a plurality of light elements, the PCB including at least one wire lead connected to a wire,
a plurality of optic devices each having a lens arranged over respective ones of the light elements to allow light emitted by each of the light elements to pass through the lens, each of the optic devices including at a base thereof a stepped flange opposing the front surface of the PCB, and
an overmold composed of an electrically insulating material and formed over the front surface of the PCB such that the overmold extends over the corresponding stepped flange of each of the optic devices to mechanically anchor the optic devices relative to the PCB, wherein the overmold includes a wire cover protruding away from an edge of the overmold, the wire cover including a wire channel dimensioned to receive therein the wire or a wire associated with another one of the assemblies,
wherein the wire associated with a first of the assemblies is received in the wire channel of a second of the assemblies.

11. The apparatus of claim 10, further comprising a heat sink, the back surface of each of the PCBs being secured to the heat sink.

12. The apparatus of claim 11, where each of the overmolds includes a sealing edge extending around at least a periphery of the overmold and extending beyond a back surface opposite the front surface of the PCB, wherein the sealing edge is deformably compressed against the heat sink to form a seal between the front surface of the PCB and a back surface of the overmold.

13. The apparatus of claim 10, wherein each of the assemblies has four sides, wherein the wire cover is four wire covers, each of the wire covers protruding away from corresponding ones of the four sides and each of the wire covers including a corresponding wire channel for receiving therein a wire.

14. The apparatus of claim 10, wherein the stepped flange includes a first step and a second step such that the first step is covered by the overmold and a major exposed surface of the overmold is flush with a top of the second step.

15. The apparatus of claim 14, wherein the electrically insulating material includes a thermoplastic or thermosetting plastic material, and the overmold is injection molded over the front surface of the PCB and over the first step of each of the optic devices such that the overmold completely covers the front surface of the PCB.

16. The apparatus of claim 10, wherein each of the light elements includes a light emitting diode (LED).

17. The apparatus of claim 10, wherein the base of each of the optic devices includes a channel formed on a bottom surface of the base opposing the front surface of the PCB, the channel being dimensioned to receive therein an adhesive for temporarily securing the optic device to the PCB as the overmold is formed thereover.

18. The assembly of claim 1, wherein each of the optic devices includes a recessed pocket forming an opening in a bottom surface of the base opposing the front surface of the PCB, the recessed pocket being dimensioned to cover one of the light elements.
